(19) United States
(12) Patent Application Publication
(10) Pub. No.: US 2006/0052570 A1
(43) Pub. Date: Mar. 9, 2006

(54) Amine-epoxy autocatalytic polymers and polyurethane products made therefrom

(76) Inventors: Joseph Gan, Strasbourg (FR); Francois M Casati, Pfaffikon (CH); Ray E Drumright, Midland, MI (US)

Correspondence Address: THE DOW CHEMICAL COMPANY, INTELLECTUAL PROPERTY SECTION, P. O. BOX 1967, MIDLAND, MI, 48641-1967, US

(21) Appl. No.: 10/534,787

(22) PCT Filed: Dec. 8, 2003
(86) PCT No.: PCT/US03/38883

§ 371 Date: May 13, 2005

Related U.S. Application Data
(60) Provisional application No. 60/434,067, filed on Dec. 17, 2002.

(51) Int. Cl. C08G 18/00

(52) U.S. Cl. 528/44

(57) ABSTRACT

The present invention pertains to low emission polyurethane products based on autocatalytic polymers made by reaction of epoxide resins with compounds containing secondary and/or tertiary amines bearing a reactive hydrogen and to processes for their manufacture.

The present invention pertains to highly reactive autocatalytic polymers made by reaction of epoxide resins with compounds containing primary, secondary and/or tertiary amines bearing reactive hydrogen, to processes for their manufacture and to products produced therefrom.

Polyether polyols based on the polymerization of alkylene oxides, and/or polyester polyols, are the major components of a polyurethane system together with isocyanates. Polyols can also be filled polyols, such as SAN (Styrene/Acrylonitrile), PIPA (polyisocyanate polyaddition) or PHD (polyurea) polyols, as described in “Polyurethane Handbook”, by G. Oertel, Hanser publisher. These systems generally contain additional components such as cross-linkers, chain extenders, surfactants, cell regulators, stabilizers, antioxidants, flame retardant additives, eventually fillers, and typically catalysts such as tertiary amines and/or organometallic salts.

The organometallic catalysts used for making polyurethanes, such as lead or mercury salts, can raise environmental issues due to leaching upon aging of the polyurethane products. Others, such as tin salts, are often detrimental to polyurethane aging.

The commonly used tertiary amine catalysts, can also give rise to undesirable properties, particularly in flexible, semi-rigid and rigid foam applications. Freshly prepared foams using these catalysts often exhibit the typical odor of the amines and give rise to increased fogging (emission of volatile products).

The presence, or formation, of even traces of tertiary amine catalyst vapors in polyurethane products having vinyl films or polycarbonate sheets exposed thereto can be disadvantageous. Specifically, the tertiary amine catalysts present in polyurethane foams have been linked to the staining of the viny film and degradation of polycarbonate sheets. This PVC staining and polycarbonate decomposition problems are especially prevalent in environments wherein elevated temperatures exist for long periods of time, such as in automobile interiors.

Various solutions to this problem have been proposed. One is the use of amine catalysts which contain a hydrogen isocyanate reactive group, that is a hydroxyl or a primary and/or a secondary amine. Such a compound is disclosed in EP 747,407. Other types of reactive monol catalysts are described in U.S. Pat. Nos. 4,122,038, 4,368,278, 4,510,269 and 5,539,007. Since they are monofunctional, these reactive amines act as chain stoppers and have a detrimental effect on the polymer build up and affect polyurethane product physical characteristics. Other types of reactive amine catalysts are claimed in U.S. Pat. No. 3,448,065, in EP 677,540 and in EP 1,109,847. A reported advantage of the catalyst compositions is that they are incorporated into the polyurethane product. However those catalysts have to be used at high levels in the polyurethane formulation to compensate for their lack of mobility during the reactions.

Various other means have been proposed for incorporating a reactive amine into a polyol. Modification of conventional polyols by partial amination has been disclosed in U.S. Pat. No. 3,838,076. Pre-polymerization of reactive amine catalysts with a polyisocyanate and a polyol is reported in PCT WO 94/02525. Use of specific amine-initiated polyols is proposed in EP 539,819, in U.S. Pat. No. 5,672,636 and in WO 01/58,976. While these approaches can reduce the amount of amine catalyst required in the system, there are disadvantages associated with each process.

Modifications of polyether polyols along the length of the polyol chain with epoxy resin-diamine or epoxy resin -amino-alcohol adducts are described in U.S. Pat. Nos. 4,518,720, 4,535,133 and 4,609,685. The addition of epoxy along the internal length of the polyol chain is reported to increase the overall functionality of the polyol chain. Flexible foam produced from such polyols reportedly have equivalent firmness and better elongation properties than foams made with a similar molecular weight unmodified polyol. Polyepoxides containing at least one tertiary nitrogen as described in U.S. Pat. No. 4,775,558 are reported to improve the thermal stability of polyurethane products.

Quaternary amine based catalyst compositions using epoxide chemistry are described in U.S. Pat. No. 3,010,963, in U.S. Pat. No. 4,404,120 and in U.S. Pat. No. 4,040,992. These are effective for isocyanate trimerization, an undesirable reaction in flexible foams, since it gives softer foam and poor aging characteristics.

Therefore, there continues to be a need for development of reactive polymers so that the addition of low molecular weight tertiary amines as catalysts for the formation of polyisocyanate polyaddition products can be avoided to the greatest possible extent. The polymers-should be suitable for the preparation of flexible, compact or cellular polyisocyanate polyaddition products and should be readily miscible with other synthesis components.

It is an object of the present invention to provide a reactive polymer produced from reaction of an epoxy resin with compounds containing an amine to form a tertiary amine or with a compound containing a tertiary amine and at least one reactive hydrogen capable of reacting with epoxy moiety. Such polymers are useful in the production of polyurethane products containing a reduced level of conventional tertiary amine catalysts, a reduced level of reactive amine catalysts or production of such products in the absence of such amine catalysts. It is an another objective of the present invention to produce polyurethane products containing a reduced level of organometallic catalyst or to produce such products in the absence of organometallic catalysts. With the reduction of the amount of amine and/or organometallic catalysts needed or elimination of such catalysts, the disadvantages associated with such catalysts can be minimized or avoided.

It is another object of the invention to have a process to adjust reactivity, such as gelation rate, and processing of a polyurethane system without having to rely on amine and/or organometallic catalysts.

It is a further object of the present invention to provide autocatalytic polymers made from tertiary amine epoxide adducts so that the industrial manufacturing process of the polyurethane product using these autocatalytic polymers and the physical characteristics of the polyurethane products made therefrom are not adversely affected and may even be improved by the reduction in the amount of conventional or reactive amine catalysts or in elimination of the amine catalyst, and/or by reduction or elimination of organometallic catalysts.

In a further aspect, the present invention is a process for the production of a polyurethane product by reaction of a mixture of
(a) at least one organic polyisocyanate with
(b) a polyol composition comprising
(b1) from 60 to 99.5 percent by weight of at least one polyol compound having a functionality of 2 to 8 and a hydroxyl number of from 15 to 800 and
(b2) from 0.5 to 40 percent by weight of at least one polymer compound having a functionality of 2 to 12, a hydroxyl number of from 15 to 600 and containing at least one tertiary amine group, wherein the weight percent is based on the total amount of polyol composition (b), and (b2) is obtained by the reactions of an epoxy resin (b3) and an amine wherein the amine is either a primary or a secondary amine or a molecule containing at least one tertiary nitrogen and at least one reactive hydrogen able to react with the epoxide; or (b2) is (b4) a hydroxyl-tipped prepolymer obtained from the reaction of an excess of (b2) or a mixture thereof with a polyisocyanate; or (b2) is (b5) a blend of several epoxides (b3) modified with one or more types of amines containing each at least one reactive hydrogen;
   (c) optionally in the presence of a blowing agent; and
   (d) optionally additives or auxiliary agents known per se for the production of polyurethane foams, elastomers and/or coatings.

In another embodiment, the present invention is a process whereby part, or the whole, of polyol (b1) is a tertiary amine based polyol and exhibits autocatalytic characteristics.

In another embodiment, the present invention is a process whereby autocatalytic polyol (b1) and/or autocatalytic polymer (b2) have specific blowing and/or gelling characteristics and polymer (b2) is able to replace at least 10 percent of the conventional catalysts, more preferably 30 percent and most preferably at least 50 percent of a conventional amine catalyst.

In another embodiment, the present invention is a process as disclosed above wherein the polyisocyanate (a) contains at least one polyisocyanate that is a reaction product of a excess of polyisocyanate with a polymer as defined by (b2).

In a further embodiment, the present invention is a process as disclosed above where the polyol (b) contains a polyol-terminated prepolymer obtained by the reaction of an excess of polyol with a polyisocyanate wherein the polyol is a polymer as defined by (b2).

The invention further provides for polyurethane products produced by any of the above processes.

In still another embodiment, the present invention is an isocyanate-terminated prepolymer based on the reaction of a polymer as defined by (b2) with an excess of a polyisocyanate.

In yet another embodiment, the present invention is a polyol-terminated prepolymer based on the reaction of a polyisocyanate with an excess of polymer as defined by (b2).

The polymers containing bonded tertiary amine functions as disclosed in the present invention are catalytically active and accelerate the addition reaction of organic polyisocyanates with polyhydroxyl or polyamino compounds and the reaction between the isocyanate and the blowing agent such as water or a carboxylic acid or its salts. The addition of these polymers to a polyurethane reaction mixture reduces or eliminates the need to include a conventional tertiary amine catalyst or an organometallic catalyst within the mixture. Since these polymers (b2) contain reactive hydrogens, they can react with the isocyanate and become part of the polymer. Their addition to polyurethane reaction mixtures can also reduce the mold dwell time in the production of molded foams or improve some polyurethane product properties.

In accordance with the present invention, a process for the production of polyurethane products is provided, whereby polyurethane products of relatively low odor and low emission of amine catalyst are produced. Furthermore, the polyurethane products produced in accordance with the invention exhibit a reduced tendency to stain vinyl films or to degrade polycarbonate sheets with which they are exposed, display excellent adhesion properties (in appropriate formulations). These advantages are achieved by including in the reaction mixture either a polymer (b2) obtained by reaction of an epoxide (b3) with a secondary amine and/or a tertiary amine molecule containing a hydrogen reactive group, or by including such polymers (b2) as partial carriers (feedstock or diluent) in polyols (b1) used in the preparation of SAN, PIPA or PHD copolymer polyols and adding them to the polyol mixture (b) or by using such polyols in a prepolymer with a polyisocyanate alone or with an isocyanate and a second polyol.

The combination of polyols and polymers used in the present invention will be a combination of (b1) and (b2) as described above and eventually (b1) containing a polyol made from an amine initiation, such as, for instance those described in WO 01/58,976 and U.S. Pat. Nos. 5,476,969 and 5,672,636. As used herein the term polyols are those materials having at least one group containing an active hydrogen atom capable of undergoing reaction with an isocyanate. Preferred among such compounds are materials having at least two hydroxyls, primary or secondary, or at least two amines, primary or secondary, carboxylic acid, or thiol groups per molecule. Compounds having at least two hydroxyl groups or at least two amine groups per molecule are especially preferred due to their desirable reactivity with polyisocyanates.

Suitable polyols (b1) that can be used to produce polyurethane materials with the autocatalytic polymers (b2) of the present invention are well known in the art and include those described herein and any other commercially available polyol and/or SAN, PIPA or PHD copolymer polyols. Such polyols are described in “Polyurethane Handbook”, by G. Oertel, Hanser publishers. Mixtures of one or more polyols and/or one or more copolymer polyols may also be used to produce polyurethane products according to the present invention.

Representative polyols include polyether polyols, polyester polyols, polyhydroxy-terminated acetal resins, hydroxyl-terminated amines and polyamines. Examples of these and other suitable isocyanate-reactive materials are described more fully in U.S. Pat. No. 4,394,491. Alternative polyols that may be used include polyalkylene carbonate-based polyols and polyphosphate-based polyols. Preferred are polyols prepared by adding an alkylene oxide, such as ethylene oxide (EO), propylene oxide (PO), butylene oxide (BO) or a combination thereof, to an initiator having from 2 to 8, preferably 2 to 6 active hydrogen atoms. Catalysis for this polymerization can be either anionic or cationic, with catalysts such as KOH, CsOH, boron trifluoride, or a double cyanide complex (DMC) catalyst such as zinc hexacyanocobaltate or quaternary phosphazenium compound.

The polyol or blends thereof employed depends upon the end use of the polyurethane product to be produced. The molecular weight or hydroxyl number of the base polyol may thus be selected so as to result in flexible, semi-flexible, integral-skin or rigid foams, elastomers or coatings, or adhesives when the polymer/polyol produced from the base polyol is converted to a polyurethane product by reaction with an isocyanate, and depending on the end product in the presence of a blowing agent. The hydroxyl number and molecular weight of the polyol or polyols employed can vary accordingly over a wide range. In general, the hydroxyl number of the polyols employed may range from 15 to 800.

In the production of a flexible polyurethane foam, the polyol is preferably a polyether polyol and/or a polyester polyol. The polyol generally has an average functionality ranging from 2 to 5, preferably 2 to 4, and an average hydroxyl number ranging from 20 to 100 mg KOH/g, preferably from 20 to 70 mgKOH/g. As a further refinement, the specific foam application will likewise influence the choice of base polyol. As an example, for molded foam, the hydroxyl number of the base polyol may be on the order of 20 to 60 with ethylene oxide (EO) capping, and for slabstock foams the hydroxyl number may be on the order of 25 to 75 and is either mixed feed EO/PO (propylene oxide) or is only slightly capped with EO or is 100 percent PO based. For elastomer applications, it will generally be desirable to utilize relatively high molecular weight base polyols, from 2,000 to 8,000, having relatively low hydroxyl numbers, for example, 20 to 50.

Typically polyols suitable for preparing rigid polyurethanes include those having an average molecular weight of 100 to 10,000 and preferably 200 to 7,000. Such polyols also advantageously have a functionality of at least 2, preferably 3, and up to 8, preferably up to 6, active hydrogen atoms per molecule. The polyols used for rigid foams generally have a hydroxyl number of 200 to 1,200 and more preferably from 300 to 800.

For the production of semi-rigid foams, it is preferred to use a trifunctional polyol with a hydroxyl number of 30 to 80.

The initiators for the production of polyols (b1) generally have 2 to 8 functional groups that will react with the alkylene oxide. Examples of suitable initiator molecules are water, organic dicarboxylic acids, such as succinic acid, adipic acid, phthalic acid and terephthalic acid and polyhydric; in particular dihydric to octahydric alcohols or dialkylene glycols, for example ethanediol, 1,2- and 1,3-propanediol, diethylene glycol, dipropylene glycol, 1,4-butanediol, 1,6-hexanediol, glycerol, trimethylolpropane, pentaerythritol, sorbitol and sucrose or blends thereof. Other initiators include compounds linear and cyclic amine compounds containing eventually a tertiary amine such as ethanoldiamine, triethanoldiamine, and various isomers of toluene diamine, ethylenediamine, N-methyl-1,2-ethanediamine, N-Methyl-1,3-propanediamine, N,N-dimethyl-1,3-diaminopropane, N,N-dimethylethanolamine, 3,3′-diamino-N-methyldipropylamine, aminopropyl-imidazole.

Amine based polyol (b1) can also contain a tertiary nitrogen in the chain, by using for instance an alkyl-aziridine as co-monomer with PO and EO, or (b1) can be capped with this teriary amine, by using for example a N,N-dialkyl-glycidylamine.

The epoxides for producing the catalytic polymers (b2) are known in the art. See for example, U.S. Pat. No. 4,609,685. The epoxide materials can be monomeric or polymeric, saturated or unsaturated, aliphatic, cycloaliphatic, aromatic or heterocyclic and may be substituted if desired with other substituents besides the epoxy groups, for example, hydroxyl, ether radicals and aromatic halogen atoms. Preferred epoxides are aliphatic or cycloaliphatic polyepoxides, more preferably diepoxides or triepoxides.

Particularly useful polyepoxide compounds which can be used in the practice of the present invention are polyepoxides having the following general formula: 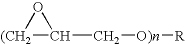
wherein R is substituted or unsubstituted aromatic, alphatic, cycloaliphatic or heterocyclic polyvalent group and n had an average value of from 1 to less than 8.

Examples of common epoxy resins include for example, the diglycidyl ethers of resorcinol, catechol, hydroquinone, bisphenol, bisphenol A, bisphenol AP (1,1-bis(4-hydroxylphenyl)-1-phenyl ethane), bisphenol F, bisphenol K, tetrabromobisphenol A, phenol-formaldehyde novolac resins, alkyl substituted phenol-formaldehyde resins, phenol-hydroxybenzaldehyde resins, cresol-hydroxybenzaldehyde resins, dicyclopentadiene-phenol resins, trimethylolpropane triglycidyl ether, dicyclopentadiene-substituted phenol resins tetramethylbiphenol, tetramethyl-tetrabromobiphenol, tetramethyltribromobiphenol, tetrachlorobisphenol A and any combination thereof.

Examples of preferred diepoxides are hydrogenated liquid aromatic epoxy resins of bis-phenol A or bisphenol F; and diepoxides D.E.R. 736, D.E.R. 732 (aliphatic epoxides) and ERL-4221 (cyclic aliphatic epoxide) available from The Dow Chemical Company. A mixture of any two or more polyexpoxides can be used in the practice of the present invention. Preferably the epoxide resin has an average equivalent weight of 90 to 500. More preferably the epoxy resin has an average equivalent weight of 150 to 400.

Polyepoxides can be prepared by epoxidizing the corresponding allyl ethers or reacting a molar excess of epichlorohydrin and an aromatic polyhydroxy compound, such as novolak, isopropylidne bisphenol, resorcinol, etc. Polyepoxides can also be obtained by reacting an epihalohydrin with either a polyhydric phenol or a polyhydric alcohol.

Usually epoxide resins contain a relatively high amount of chlorine, both under the form of chloromethyl groups and as ionic chloride. For instance D.E.R. 736, an epoxide resin available from The Dow Chemical Company, has about 10 percent total chlorine. Of particular interest for the present invention are low chlorine epoxy resins with less than 5 percent and more preferably less than 1 percent total chlorine.

The amine compounds for producing the autocatalytic polyols of (b2) are those which react with an epoxide moiety to produce a tertiary amine. Such compounds include secondary amines and/or molecules which contain a tertiary amine and at least one reactive hydrogen able to react with an epoxide. Groups reactive with epoxides include primary or secondary, aliphatic or aromatic amines; primary, secondary and/or tertiary alcohols; amides; ureas; and urethanes.

Generally, secondary amines can be represented by HNR₂¹ where each R¹ is independently a moiety having 1 to 20 carbon atoms, such as a linear or branched alkyl or alkylaryl, or may be attached together with the nitrogen atom and optionally other hetero atoms and alkyl-substituted hetero atoms to form one or two saturated heterocyclic or aromatic ring(s).

Compounds containing at least one tertiary nitrogen and at least one hydrogen atom reactive to an epoxide can be represented by
(R³)ₓ-A-(R²-M)ₓ-(R²)_{y}
where A is either hydrogen, nitrogen or oxygen;
x is 0, 1 or 2;
z is 1 or 2
with the provisos x is zero when A is hydrogen, x and z are 1 when A is oxygen, and when A is nitrogen x and z can be 1 or 2 with the sum of x and z being 3;
R² at each occurrence is independently a moiety having 1 to 20 carbon atoms;
R³ is hydrogen or a moiety having 1 to 20 carbon atoms;
M is an amine or polyamine, linear, branched or cyclic, with at least one tertiary amine group; and
y is an integer from 0 to 6. Preferably M has a molecular weight of 30 to 300. More preferably M has a molecular weight of 50 to 200.

Examples of amines that are commercially available and that can be used to manufacture polyols of (b2), specifically (b2a), (b2b), (b2c), are dimethylamine, diethylamine, N,N-dimethylethanolamine, N,N-dimethyl-N′-ethylenediamine, 3-dimethylamino-1-propanol, 1-dimethylamino-2-propanol, 3-(dimethylamino) propylamine, dicyclohexylamine, 1-(3-aminopropyl)-imidazole, 3-hydroxymethyl quinuclidine, imidazole, 2-methyl imidazole, 1-(2-aminoethyl)-piperazine, 1-methyl-piperazine, 3-quinuclidinol, tetramethylamino-bis-propylamine, 2-(2-aminoethoxy)-ethanol, N,N-dimethylaminoethyl-N′-methyl ethanolamine and 2-(methylamino)-ethanol. Other types of amines which can be used with the present invention are N,N′-dimethylethylenediamine, 4,6-dihydroxypyrimidine, 2,4-diamino-6-hydroxypyrimidine, 2,4-diamino-6-methyl-1,3,5-triazine, 3-aminopyridine, 2,4-diaminopyrimidine, 2-phenyl-imino-3-(2-hydroxyethyl)-oxazalodine,N-(-2-hydroxyethyl)-2-methyl-tetrahydropyrimidine, N-(2-hydroxyethyl)-imidazoline, 2,4-bis-(N-methyl-2-hydroxytethylamino)-6-phenyl-1,3,5-triazine, bis-(dimethylaminopropyl)amino-2-propanol, 2-(2-methylaminoethyl)-pyridine, 2-(methylamino)-pyridine, 2-methylaminomethyl-1,3-dioxane, and dimethylaminopropyl urea.

Amines used in the present invention can also be polymers, such as amine capped polyols or polyamines. In that case monomeric epoxy compounds are preferred.

The autocatalytic polymers (b2) are epoxides reacted with an amine based compound as described above. When using a polyepoxide resin it is preferred to have at least 70 percent of these epoxide groups reacted with the amine, more preferably 90 percent and most preferably 100 percent. More than one amine or aminoalcohols can be reacted with the epoxide resin.

The production of polymers (b2) is based on the reactions of an epoxide with at least one amine based molecule to obtain a tertiary amine function in the final polymer molecule. The two or more reactants can be mixed together or the epoxide can first be pre-reacted partially with the amine(s) before further addition or vice versa the amine(s) can be in excess at the beginning of the reaction. Stoichiometric ratio between the amine and the epoxy resin can be used, or excess of one of the components may be favored to adjust final product characteristics. Addition of heat or cooling and proper catalysis may be used to control these reactions. Additionally other compounds can be used to help producing these amine epoxy adducts, that is co-reactants, solvents etc. It is important to note that these epoxide-reactive hydrogen reactions generate hydroxyl groups.

The properties of the autocatalytic polyols (b2) can vary widely as described above for polyol (b1) and such parameters as average molecular weight, hydroxyl number, functionality, etc. will generally be selected based on the end use application of the formulation, that is, what type of polyurethane product.

The polymers of (b2) include conditions where the polymer is reacted with a polyisocyanate to form a prepolymer and subsequently a polyol is optionally added to such a prepolymer.

The limitations described with respect to the characteristics of the polyols (b1) and polymer (b2) above are not intended to be restrictive but are merely illustrative of the large number of possible combinations for the polyol or polyols used.

In a preferred embodiment the epoxide of polymer (b2) is a diepoxide and the amine based molecule containing at least one reactive hydrogen has a methyl-amino or a dimethyl amino or an amidine or a pyridine or a pyrimidine or a quinuclidine or an adamantane or a triazine or an imidazole or a piperazine structure combined with secondary and/or primary amines and/or secondary and/or primary hydroxyls.

The weight ratio of (b1) to (b2) will vary depending on the amount of additional catalyst one may desire to add to the reaction mix and to the reaction profile required by the specific application. Generally if a reaction mixture with a base level of catalyst having specified curing time, (b2) is added in an amount so that the curing time is equivalent where the reaction mix contains at least 10 percent by weight less catalyst. Preferably the addition of (b2) is added to give a reaction mixture containing 20 percent less catalyst than the base level. More preferably the addition of (b2) will reduce the amount of catalyst required by 30 percent over the base level. For some applications, the most preferred level of (b2) addition is where the need for a fugitive or reactive tertiary amine catalysts or organometallic salt is eliminated.

Combination of two or more autocatalytic polymers of (b2) type can also be used with satisfactory results in a single polyurethane formulation when one wants for instance to adjust blowing and gelling reactions modifying the epoxide and/or the amine structures with different tertiary amines, functionalities, equivalent weights, etc, and their respective amounts in the formulations.

Polyols pre-reacted with polyisocyanates and polymer (b2) with no free isocyanate functions can also be used in the polyurethane formulation. Isocyanate prepolymers based on polyol (b2) can be prepared with standard equipment, using conventional methods, such a heating the polyol (b2) in a reactor and adding slowly the isocyanate under stirring and then adding eventually a second polyol, or by prereacting a first polyol with a diisocyanate and then adding polymer (b2).

The isocyanates which may be used with the autocatalytic polymers of the present invention include aliphatic, cycloaliphatic, arylaliphatic and aromatic isocyanates. Aromatic isocyanates, especially aromatic polyisocyanates are preferred.

Examples of suitable aromatic isocyanates include the 4,4′-, 2,4′ and 2,2′-isomers of diphenylmethane diisocyante (MDI), blends thereof and polymeric and monomeric MDI blends toluene-2,4- and 2,6-diisocyanates (TDI), m- and p-phenylenediisocyanate, chlorophenylene-2,4-diisocyanate, diphenylene-4,4′-diisocyanate, 4,4′-diisocyanate-3,3′-dimehtyldiphenyl, 3-methyldiphenyl-methane-4,4′-diisocyanate and diphenyletherdiisocyanate and 2,4,6-triisocyanatotoluene and 2,4,4′-triisocyanatodiphenylether.

Mixtures of isocyanates may be used, such as the commercially available mixtures of 2,4- and 2,6-isomers of toluene diisocyantes. A crude polyisocyanate may also be used in the practice of this invention, such as crude toluene diisocyanate obtained by the phosgenation of a mixture of toluene diamine or the crude diphenylmethane diisocyanate obtained by the phosgenation of crude methylene diphenylamine. TDI/MDI blends may also be used. MDI or TDI based prepolymers can also be used, made either with polyol (b1), polyol (b2) or any other polyol as described heretofore. Isocyanate-terminated prepolymers are prepared by reacting an excess of polyisocyanate with polyols, including aminated polyols or imines/enamines thereof, or polyamines.

Examples of aliphatic polyisocyanates include ethylene diisocyanate, 1,6-hexamethylene diisocyanate, isophorone diisocyanate, cyclohexane 1,4-diisocyanate, 4,4′-dicyclohexylmethane diisocyanate, saturated analogues of the above mentioned aromatic isocyanates and mixtures thereof.

The preferred polyisocyantes for the production of rigid or semi-rigid foams are polymethylene polyphenylene isocyanates, the 2,2′, 2,4′ and 4,4′ isomers of diphenylmethylene diisocyanate and mixtures thereof. For the production of flexible foams, the preferred polyisocyanates are the toluene-2,4- and 2,6-diisocyanates or MDI or combinations of TDI/MDI or prepolymers made therefrom.

Isocyanate tipped prepolymer based on polymer (b2) can also be used in the polyurethane formulation.

For rigid foam, the organic polyisocyanates and the isocyanate reactive compounds are reacted in such amounts that the isocyanate index, defined as the number or equivalents of NCO groups divided by the total number of isocyanate reactive hydrogen atom equivalents multiplied by 100, ranges from 80 to less than 500 preferably from 90 to 100 in the case of polyurethane foams, and from 100 to 300 in the case of combination polyurethane-polyisocyanurate foams. For flexible foams, this isocyanate index is generally between 50 and 120 and preferably between 75 and 110.

For elastomers, coating and adhesives the isocyanate index is generally between 80 and 125, preferably between 100 to 110.

For producing a polyurethane-based foam, a blowing agent is generally required. In the production of flexible polyurethane foams, water is preferred as a blowing agent. The amount of water is preferably in the range of from 0.5 to 10 parts by weight, more preferably from 2 to 7 parts by weight based on 100 parts by weight of the polyol. Carboxylic acids or salts are also used as reactive blowing agents. Other blowing agents can be liquid or gaseous carbon dioxide, methylene chloride, acetone, pentane, isopentane, methylal or dimethoxymethane, dimethylcarbonate. Use of artificially reduced atmospheric pressure can also be contemplated with the present invention.

In the production of rigid polyurethane foams, the blowing agent includes water, and mixtures of water with a hydrocarbon, or a fully or partially halogenated aliphatic hydrocarbon. The amount of water is preferably in the range of from 2 to 15 parts by weight, more preferably from 2 to 10 parts by weight based on 100 parts of the polyol. With excessive amount of water, the curing rate becomes lower, the blowing process range becomes narrower, the foam density becomes lower, or the moldability becomes worse. The amount of hydrocarbon, the hydrochlorofluorocarbon, or the hydrofluorocarbon to be combined with the water is suitably selected depending on the desired density of the foam, and is preferably not more than 40 parts by weight, more preferably not more than 30 parts by weight based on 100 parts by weight of the polyol. When water is present as an additional blowing agent, it is generally present in an amount from 0.5 to 10, preferably from 0.8 to 6 and more preferably from 1 to 4 and most preferably from 1 to 3 parts by total weight of the total polyol composition.

Hydrocarbon blowing agents are volatile C₁ to C₅ hydrocarbons. The use of hydrocarbons is known in the art as disclosed in EP 421 269 and EP 695 322. Preferred hydrocarbon blowing agents are butane and isomers thereof, pentane and isomers thereof (including cyclopentane), and combinations thereof.

Examples of fluorocarbons include methyl fluoride, perfluoromethane, ethyl fluoride, 1,1-difluoroethane, 1,1,1-trifluoroethane (HFC-143a), 1,1,1,2-tetrafluoroethane (HFC-134a), pentafluoroethane, difluoromethane, perfluoroethane, 2,2-difluoropropane, 1,1,1-trifluoropropane, perfluoropropane, dichloropropane, difluoropropane, perfluorobutane, perfluorocyclobutane.

Partially halogenated chlorocarbons and chlorofluorocarbons for use in this invention include methyl chloride, methylene chloride, ethyl chloride, 1,1,1-trichloroethane, 1,1-dichloro-1-fluoroethane (FCFC-141b), 1-chloro-1,1-difluoroethane (HCFC-142b), 1,1-dichloro-2,2,2-trifluoroethane (HCHC-123) and 1-chloro-1,2,2,2-tetrafluoroethane (HCFC-124).

Fully halogenated chlorofluorocarbons include trichloromonofluoromethane (CFC-11) dichlorodifluoromethane (CFC-12), trichlorotrifluoroethane (CFC-113), 1,1,1-trifluoroethane, pentafluoroethane, dichlorotetrafluoroethane (CFC-114), chloroheptafluoropropane, and dichlorohexafluoropropane. The halocarbon blowing agents may be used in conjunction with low-boiling hydrocarbons such as butane, pentane (including the isomers thereof), hexane, or cyclohexane or with water.

In addition to the foregoing critical components, it is often desirable to employ certain other ingredients in preparing polyurethane polymers. Among these additional ingredients are surfactants, preservatives, flame retardants, colorants, antioxidants, reinforcing agents, stabilizers and fillers.

In making polyurethane foam, it is generally preferred to employ an amount of a surfactant to stabilize the foaming reaction mixture until it cures. Such surfactants advantageously comprise a liquid or solid organosilicone surfactant. Other surfactants include polyethylene glycol ethers of long-chain alcohols, tertiary amine or alkanolamine salts of long-chain alkyl acid sulfate esters, alkyl sulfonic esters and alkyl arylsulfonic acids. Such surfactants are employed in amounts sufficient to stabilize the foaming reaction mixture against collapse and the formation of large, uneven cells. Typically, 0.2 to 3 parts of the surfactant per 100 parts by weight total polyol (b) are sufficient for this purpose.

One or more catalysts for the reaction of the polyol (and water, if present) with the polyisocyanate can be used. Any suitable urethane catalyst may be used, including tertiary amine compounds, amines with isocyanate reactive groups and organometallic compounds. Preferably the reaction is carried out in the absence of an amine or an organometallic catalyst or a reduced amount as described above. Exemplary tertiary amine compounds include triethylenediamine, N-methylmorpholine, N,N-dimethylcyclohexylamine, pentamethyldiethylenetriamine, tetramethylethylenediamine, bis (dimethylaminoethyl)ether, 1-methyl-4-dimethylaminoethyl-piperazine, 3-methoxy-N-dimethylpropylamine, N-ethylmorpholine, dimethylethanolamine, N-cocomorpholine, N,N-dimethyl-N′,N′-dimethyl isopropylpropylenediamine, N,N-diethyl-3-diethylamino-propylamine and dimethylbenzylamine. Exemplary organometallic catalysts include organomercury, organolead, organoferric and organotin catalysts, with organotin catalysts being preferred among these. Suitable tin catalysts include stannous chloride, tin salts of carboxylic acids such as dibutyltin di-laurate, as well as other organometallic compounds such as are disclosed in U.S. Pat. No. 2,846,408, or in EP 1,013,704, EP 1,167,410, EP 1,167,411. A catalyst for the trimerization of polyisocyanates, resulting in a polyisocyanurate, such as an alkali metal alkoxide may also optionally be employed herein. The amount of amine catalysts can vary from 0.02 to 5 percent in the formulation or organometallic catalysts from 0.001 to 1 percent in the formulation can be used.

A crosslinking agent or a chain extender may be added, if necessary. The crosslinking agent or the chain extender includes low-molecular polyhydric alcohols such as ethylene glycol, diethylene glycol, 1,4-butanediol, and glycerin; low-molecular amine polyol such as diethanolamine and triethanolamine; polyamines such as ethylene diamine, xlylenediamine, and methylene-bis(o-chloroaniline). The use of such crosslinking agents or chain extenders is known in the art as disclosed in U.S. Pat. Nos. 4,863,979 and 4,963,399 and EP 549,120.

When preparing rigid foams for use in construction, a flame retardant is generally included as an additive. Any known liquid or solid flame retardant can be used with the autocatalytic polyols of the present invention. Generally such flame retardant agents are halogen-substituted phosphates and inorganic flame proofing agents. Common halogen-substituted phosphates are tricresyl phosphate, tris(1,3-dichloropropyl phosphate, tris(2,3-dibromopropyl) phosphate and tetrakis (2-chloroethyl)ethylene diphosphate. Inorganic flame retardants include red phosphorous, aluminum oxide hydrate, antimony trioxide, ammonium sulfate, expandable graphite, urea or melamine cyanurate or mixtures of at least two flame retardants. In general, when present, flame retardants are added at a level of from 5 to 50 parts by weight, preferable from 5 to 25 parts by weight of the flame retardant per 100 parts per weight of the total polyol present.

The applications for foams produced by the present invention are those known in the industry. For example rigid foams are used in the construction industry and for insulation for appliances and refrigerators. Flexible foams and elastomers find use in applications such as furniture, shoe soles, automobile seats, sun visors, steering wheels, armrests, door panels, noise insulation parts and dashboards.

Processing for producing polyurethane products are well known in the art. In general components of the polyurethane-forming reaction mixture may be mixed together in any convenient manner, for example by using any of the mixing equipment described in the prior art for the purpose such as described in “polyurethane Handbook”, by G. Oertel, Hanser publisher.

The polyurethane products are either produced continuously or discontinuously, by injection, pouring, spraying, casting, calendering, etc; these are made under free rise or molded conditions, with or without release agents, in-mold coating, or any inserts or skin put in the mold. In case of flexible foams, those can be mono- or dual-hardness.

For producing rigid foams, the known one-shot prepolymer or semi-prepolymer techniques may be used together with conventional mixing methods including impingement mixing. The rigid foam may also be produced in the form of slabstock, moldings, cavity filling, sprayed foam, frothed foam or laminates with other material such as paper, metal, plastics or wood-board. Flexible foams are either free rise and molded while microcellular elastomers are usually molded.

The following examples are given to illustrate the invention and should not be interpreted as limiting in anyway. Unless stated otherwise, all parts and percentages are given by weight.

A description of the raw materials used in the examples is as follows.

| | |
|---|---|
| DEOA 85 percent | is 85 percent pure diethanolamine and 15 |
| | percent water. |
| DMAPA | is 3-dimethylamino-1-propylamine. |
| 2-Methylimidazole | is a tertiary amine with a reactive |
| | hydrogen available from Aldrich. |
| ETA | is Ethanolamine available from Aldrich |
| D.E. R. 732 | is an aliphatic diepoxide resin with an |
| | EEW (epoxy equivalent weight) of 325 |
| | available from The Dow Chemical Company |
| Epoxide resin A | is an aliphatic diepoxide resin with an |
| | EEW (epoxy equivalent weight) of 325 and |
| | containing less than 1 percent Chloride. |
| Dabco DC 5169 | is a silicone-based surfactant |
| | available from Air Products and |
| | Chemicals Inc. |
| Dabco 33 LV | is a tertiary amine catalyst available |
| | from Air Products and Chemicals Inc. |
| Niax A-1 | is a tertiary amine catalyst available |
| | from Crompton Corporation. |
| Polyol B | is a 1,700 equivalent weight |
| | propoxylated tetrol initiated with |
| | 3,3′-diamino-N-methyl dipropylamine |
| | and capped with 15 percent Ethylene |
| | oxide. |
| SPECFLEX NC 632 | is a 1,700 EW polyoxypropylene |
| | polyoxyethylene polyol initiated with a |
| | blend of glycerol and sorbitol available |
| | from The Dow Chemical Company. |
| SPECFLEX NC-700 | is a 40 percent SAN based copolymer |
| | polyol with an average hydroxyl number |
| | of 20 available from The Dow |
| | Chemical Company. |
| VORANATE T-80 | is TDI 80/20 isocyanate available from |
| | The Dow Chemical Company. |

All foams were made in the laboratory with an Admiral high pressure machine equipped with Krauss-Maffei MK-12/16-UL-4K mix-head and by preblending polyols, surfactants, crosslinkers, catalysts and water. The reactants are poured in a 40×40×10 cm aluminum mold heated at 60° C. which is subsequently closed. The mold had previously been sprayed with the release agent Klueber 41-2013 available from Klueber Chemie. Curing at 4 minutes is assessed by manually demolding the part, looking for defects and measuring the 50 percent Indentation force first cycle (crushing Force) and same measurement after foam crushing (Hot IFD). Free rise reactivity with cream, gel and rise times, as defined in “Flexible Polyurethane Foams” by Ron Herrington et al, ed The Dow Chemical Company, are also recorded.

BVT (Brookfield Viscosity) tests are carried out as follows: 100 grams of Specflex NC-632 are allowed to equilibrate at 25° C. and then blended with the autocatalytic polymer. Voranate T-80 is then added at a concentration corresponding to an index of 110. The viscosity build up over time is measured until full gelation (20,000 mPa·s) is reached. This time is recorded as well as final viscosity if gelation is not obtained after 11 minutes. In the case of autocatalytic polymers, these are blended at various ratios with the control polyol. In all cases no catalysts are added.

### EXAMPLE 1

A one liter flask was charged with 100 grams (1.218 mole) of 2-methylimidazole and 264.5 grams (0.814 mole epoxide groups) of D.E.R. 732. The flask was fitted with an addition funnel containing an additional 250 grams (0.770 mole epoxy groups) of D.E.R. 732 and placed under an atmosphere of nitrogen. The flask was placed in a heating bath at 60° C. The internal temperature was controlled at 60° C. by applying heating or cooling as necessary. After 3 hours of reaction time, the contents of the addition funnel were added dropwise over the course of 4 hours. The highest observed temperature during the reaction was 78° C. After all the D.E.R. had been added, the reaction mixture was stirred at 60° C. overnight. A light yellow syrup, 603.7 grams was obtained. The product contains 1.988 mmol/g of 2-methylimidazole derived species. The level of ionic chloride in the sample is 43,000 ppm.

### EXAMPLE 2

A 100 mL flask was charged with 12.5 grams (152.2 mmole) of 2-methylimidazole, and 28.2 grams (99 mmole epoxide groups) of epoxide resin A. The flask was fitted with an addition funnel containing an additional 28.2 grams of epoxide resin A and placed under an atmosphere of nitrogen. The flask was placed in a heating bath at 60° C. The internal temperature was controlled at 60° C. by applying heating or cooling as necessary. After 2 hours of reaction time, the contents of the addition funnel were added dropwise over the course of 6 hours. The highest observed temperature during the reaction was 65° C. After all the D.E.R. had been added, the reaction mixture was stirred at 60° C. overnight. A red/brown syrup, 66.9 grams, was obtained. The level of ionic chloride in the sample is less than 1 ppm.

### EXAMPLES 3 and 4

The procedure of Example 2 was followed using the following components, parts by weight:
(3) Epoxide A/ETA/2-Methylimidazole 83.95/3.7/12.35
(4) Epoxide A/DMAPA/2-Methylimidazole 84.4/5.3 /10.3

The final product in both cases was a liquid syrup.

### EXAMPLES 5, 6, 7, 8

BVT tests were carried out with these samples and compared with straight 2-methylimidazole and with Dabco 33LV (triethylenediamine), a conventional amine catalyst. Both amines were dissolved in 5 parts by weight of NMP (1-methyl-2-pyrrolidinone) prior to addition of 95 parts by weight of Specflex NC-632. Results are reported in the table below:

| | Example | | | | | |
|---|---|---|---|---|---|---|
| | | | | | Comparative | Comparative |
| | 5 | 6 | 7 | 8 | A | B |
| Type of catalyst | Example | Example | Example | Example | Dabco | 2-Methyl- |
| | 1 | 2 | 3 | 4 | 33 LV | imidazole |
| Level of product | 3 | 0.5 | 0.6 | 0.6 | 0.26 | 0.5 |
| (percent) | | | | | | |
| Time to gel (s) | 390 | 450 | 135 | 245 | 400 | NA |
| Viscosity at 11 min | >20,000 | >20,000 | >20,000 | >20,000 | >20,000 | 2,100 |
| (mPa · s) | | | | | | |

These examples 5 to 8 show that these amine-epoxide adducts are very potent autocatalytic polymers, especially the polymer of examples 2 and 6 based on low chlorine epoxy resin A. The results also show that 2-methylimidazole is not a strong catalyst by itself since it did not give full gelation after 11 minutes.

### EXAMPLES 9, 10, 11, 12 and 13

Good foam pads were produced with the following formulation:

| | |
|---|---|
| Amine-epoxy adduct | x |
| Specflex NC-632 | (20 − x) |
| Specflex NC-700 | 30 |
| Polyol B | 50 |
| Water | 3.5 |
| DEOA 85 percent | 0.8 |
| Dabco DC-5169 | 0.6 |
| Voranate T-80 | index 100 |

In formulation of example 13 Polyol B is replaced by Specflex NC-632 and 0.05 PHP Niax A-1 is added instead. Comparative example C has no amine-epoxy adduct and no amine catalyst. Comparative example D contains 0.4 PHP Dabco 33 LV Results are reported in table below:

| | Example | | | | | | |
|---|---|---|---|---|---|---|---|
| | | | | | Comparative | Comparative | |
| | 9 | 10 | 11 | 12 | C | D | 13 |
| Adduct of example | 1 | 2 | 3 | 4 | No amine | Dabco 33 LV | 2 |
| | | | | | catalyst | 0.4 PHP | |
| Level x (PHP) | 2.0 | 1.5 | 2.7 | 2.7 | 0 | 0 | 1.5 |
| Cream time (s) | 3 | 5 | 3 | 4 | NA | 4 | 3 |
| Gel time (s) | 50 | 53 | 40 | 44 | NA | 53 | 53 |
| Rise time (s) | 100 | 103 | 65 | 72 | NA | 96 | 89 |
| Part weight (g) | 590 | 604 | 612 | 609 | Partial | 600 | 600 |
| | | | | | collapse | | |
| Crushing Force (N) | 730 | 1,080 | 1,360 | 1,030 | Uncured | 1,240 | 1,100 |
| Hot IFD (N) | 120 | 150 | 180 | 155 | NA | 180 | 140 |

### EXAMPLE 14

The foam of example 9 was tested for volatiles according to AUDI-PV 3341 and for VOC (Volatile Organic Components) and FOG (Fogging) according to Daimler-Chrysler PB-VWT-709 test methods. No amine volatiles-were detected from these foams.

Other embodiments of the invention will be apparent to those skilled in the art from a consideration of this specification or practice of the invention disclosed herein. It is intended that the specification and examples be considered as exemplary only, with the true scope and spirit of the invention being indicated by the following claims.

1. A process for the production of a polyurethane product by reaction of a mixture of
(a) at least one organic polyisocyanate with
(b) a polyol composition comprising
(b1) from 60 to 99.5 percent by weight of a polyol compound having a functionality of 2 to 8 and a hydroxyl number of from 15 to 800 and
(b2) from 0.5 to 40 percent by weight of at least one polymer compound having a functionality of 1 to 12, a hydroxyl number of from 20 to 600 and containing at least one tertiary amine group, wherein the weight percent is based on the total amount of polyol composition (b), and
(b2) is obtained by the reactions of an epoxy resin (b3) and an amine wherein the amine is either a primary or a secondary amine or a molecule containing at least one tertiary nitrogen and at least one reactive hydrogen able to react with the epoxide; or
(b2) is (b4) a hydroxyl-tipped prepolymer obtained from the reaction of an excess of (b2) or a mixture thereof with a polyisocyanate; or
(b2) is (b5) a blend of several epoxides (b3) modified with one or more types of amines containing each at least one reactive hydrogen;
(c) optionally in the presence of a blowing agent; and
(d) optionally additives or auxiliary agents known per se for the production of polyurethane foams, elastomers and/or coatings.

2. The process of claim 1 wherein polyol (b1) comprises a polyether polyol, polyester polyol, polyhydroxy-terminated acetal resin, hydroxyl-terminated amine polyol, hydroxyl-terminated polyamine polyol or a mixture thereof.

3. The process of claim 1 wherein polyol (b1) comprises a polyester polyol, a polyether polyol or a mixture thereof.

4. The process of claim 1 wherein the secondary amine used for obtaining a polyol of (b2) is represented by HNR¹₂ where each R¹ is independently a compound having 1 to 20 carbon atoms or may be attached together with the nitrogen atom and optionally other hetero atoms and alkyl-substituted hetero atoms to form one or two saturated heterocyclic or aromatic ring(s).

5. The process of claim 1 wherein the tertiary amine used for obtaining a polyol of (b2), is represented by
(R³)ₓ-A-(R²-M)_{z}—(R²)_{y}
where A is either hydrogen, nitrogen or oxygen;
x is 0, 1 or 2;
z is 1 or 2
with the provisos x is zero when A is hydrogen, x and z are 1 when A is oxygen, and when A is nitrogen x and z can be 1 or 2 with the sum of x and z being 3;
R² at each occurrence is independently a moiety having 1 to 20 carbon atoms;
R³ is hydrogen or a moiety having 1 to 20 carbon atoms;
M is an amine or polyamine, linear, branched or cyclic, with at least one tertiary amine group; and
y is an integer from 0 to 6.

6. The process of claim 1 wherein the secondary or tertiary amine used for the production of polyol (b2) is one or more amines selected from the group consisting of dimethylamine, diethylamine, N,N-dimethylethanolamine, N,N-dimethyl-N′-ethylenediamine, 3-dimethylamino-1-propanol, 1-dimethylamino-2-propanol, 3-(dimethylamino) propylamine, dicyclohexylamine, 1-(3-aminopropyl)-imidazole, 3-hydroxymethyl quinuclidine, imidazole, 2-methyl imidazole, 1-(2-aminoethyl)-piperazine, 1-methyl-piperazine, 3-quinuclidinol, tetramethylamino-bis-propylamine, 2-(2-aminoethoxy)-ethanol, N,N-dimethylaminoethyl-N′-methyl ethanolamine and 2-(methylamino)-ethanol.

7. The process of claim 1 wherein the secondary or tertiary amine used for the production of polyol (b2) is one or more amines selected from the group consisting of N,N′-dimethylethylenediamine, 4,6-dihydroxypyrimidine, 2,4-diamino-6-hydroxypyrimidine, 2,4-diamino-6-methyl-1,3,5-triazine, 3-aminopyridine, 2,4-diaminopyrimidine, 2-phenyl-imino-3-(2-hydroxyethyl)-oxazalodine,N-(−2-hydroxyethyl)-2-methyl-tetrahydropyrimidine, N-(2-hydroxyethyl)-imidazoline,2,4-bis-(N-methyl-2-hydroxytethylamino)-6-phenyl-1,3,5-triazine, bis-(dimethylaminopropyl)amino-2-propanol, 2-(2-methylaminoethyl)-pyridine, 2-(methylamino)-pyridine, 2-methylaminomethyl-1,3-dioxane and dimethylaminopropyl urea.

8. The process of claim 1 wherein the epoxy resin for the production of polyol (b2) is represented by the general formula general formula: 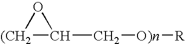
wherein R is substituted or unsubstituted aromatic, alphatic, cycloaliphatic or heterocyclic polyvalent group and n had an average value of from 1 to less than 8.

9. The process of claim 1 wherein the epoxy resin for the production of polyol (b2) is selected from one or more of the group consisting-diglycidyl ethers of resorcinol, catechol, hydroquinone, bisphenol, bisphenol A, bisphenol AP (1,1-bis(4-hydroxylphenyl)-1-phenyl ethane), bisphenol F, bisphenol K, tetrabromobisphenol A, phenol-formaldehyde novolac resins, alkyl substituted phenol-formaldehyde resins, phenol-hydroxybenzaldehyde resins, cresol-hydroxybenzaldehyde resins, dicyclopentadiene-phenol resins, trimethylolpropane triglycidyl ether, dicyclopentadiene-substituted phenol resins tetramethylbiphenol, tetramethyl-tetrabromobiphenol, tetramethyltribromobiphenol, and tetrachlorobisphenol A and aliphatic diepxoids.

10. The process of claim 9 wherein the epoxy resin for the production of polyol (b2) is an aliphatic diepoxide.

11. The process of any one of claims 1-10 wherein the polyurethane product is a rigid foam and the polyol (b1) and (b2) have an average functionality of 3 to 6 and an average hydroxyl number of 200 to 800.

12. The process of claim 11 wherein the blowing agent for producing the rigid foam is a hydrocarbon, a hydrochlorofluorocarbon, a hydrofluorocarbon, a hydrochlorocarbon or a mixture thereof.

13. A rigid foam produced by the process of claim 12.

14. The process of any one of claim 1-10 wherein the polyurethane product is a flexible foam and the polyol (b1) and (b2) have an average functionality of 2 to 4 and an average hydroxyl number of 20 to 100.

15. A flexible foam produced by the process of claim 14.

16. A polyol formulation comprising (b1) from 60 to 99.5 percent by weight of a polyol compound having a functionality of 2 to 8 and a hydroxyl number of from 15 to 800 and
(b2) from 0.5 to 40 percent by weight of at least one polymer compound having a functionality of 2 to 12, a hydroxyl number of from 20 to 600 and containing at least one tertiary amine group,
wherein the weight percent is based on the total amount of polyol composition (b), and
(b2) is obtained by the reactions of an epoxy resin (b3) and an amine wherein the amine is either a primary or a secondary amine or a molecule containing at least one tertiary nitrogen and at least one reactive hydrogen able to react with the peroxide; or
(b2) is (b4) a hydroxyl-tipped prepolymer obtained from the reaction of an excess of (b2) or a mixture thereof with a polyisocyanate; or
(b2) is (b5) a blend of several epoxides (b3) modified with one or more types of amines containing each at least one reactive hydrogen.
